(19) United States
(12) Patent Application Publication
(10) Pub. No.: US 2025/0393041 A1
(43) Pub. Date: Dec. 25, 2025

(54) AUTOMATIC SCHEDULING OFFSET THRESHOLD

(71) Applicant: QUALCOMM Incorporated, San Diego, CA (US)

(72) Inventors: Gabi SARKIS, San Diego, CA (US); Jing JIANG, San Diego, CA (US); Hari SANKAR, San Diego, CA (US); Diana MAAMARI, San Diego, CA (US); Michael Lee MCCLOUD, San Diego, CA (US); Tingfang JI, San Diego, CA (US)

(21) Appl. No.: 18/749,463

(22) Filed: Jun. 20, 2024

(51) Int. Cl. H04W 72/12

(52) U.S. Cl. CPC H04W 72/12

(57) ABSTRACT

Methods, systems, and devices for wireless communications are described. Generally, the described techniques may enable a user equipment (UE) to automatically (e.g., without explicit configuration signaling) change a scheduling offset threshold from a first scheduling offset threshold to a second scheduling offset threshold. For example, the UE may use the first scheduling offset threshold prior to receiving a first control message, and then the UE may change to the second scheduling offset threshold based on receiving the first control message. The second scheduling offset threshold may be relatively smaller than the first scheduling offset threshold. Additionally, or alternatively, the UE may automatically adjust a communication configuration from a first communication configuration to a second communication configuration based on receiving the first control message.

### FIELD OF TECHNOLOGY

The following relates to wireless communications, including automatic scheduling offset threshold.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may receive an indication of a scheduling offset between a grant and its corresponding data transmission.

### SUMMARY

The systems, methods, and devices of this disclosure each have several innovative aspects, no single one of which is solely responsible for the desirable attributes disclosed herein.

A method for wireless communications for a user equipment (UE) by an apparatus is described. The method may include receiving, during a first transmission time interval (TTI), a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset, monitoring for, or transmitting, the first transmission during the second TTI, and receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

An apparatus for wireless communications for a UE is described. The apparatus may include one or more memories storing processor executable code, and one or more processors coupled with the one or more memories. The one or more processors may individually or collectively be operable to execute the code to cause the apparatus to receive, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset, monitor for, or transmitting, the first transmission during the second TTI, and receive, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

Another apparatus for wireless communications for a UE is described. The apparatus may include means for receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset, means for monitoring for, or transmitting, the first transmission during the second TTI, and means for receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

A non-transitory computer-readable medium storing code for wireless communications for a UE is described. The code may include instructions executable by one or more processors to receive, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset, monitor for, or transmitting, the first transmission during the second TTI, and receive, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

Some examples of the method, apparatus, and non-transitory computer-readable medium described herein may further include operations, features, means, or instructions for receiving, during a fourth TTI, a third control message that indicates a third scheduling offset for a third transmission, where the third scheduling offset satisfies a third scheduling offset threshold and indicates that the third transmission may be scheduled in a fifth TTI that occurs after the fourth TTI in accordance with the third scheduling offset, and where the second scheduling offset threshold may be changed to the third scheduling offset threshold based on a trigger event.

In some examples of the method, apparatus, and non-transitory computer-readable medium described herein, the trigger event includes a physical downlink control channel (PDCCH) skipping indication, a search space set group (SSSG) change indication, an end of burst indication, a bandwidth part (BWP) change indication, or any combination thereof. In some examples of the method, apparatus, and non-transitory computer-readable medium described herein, the trigger event includes an expiration of a timer and a duration of the timer may be reset based on receipt of each respective control message. In some examples of the method, apparatus, and non-transitory computer-readable medium described herein, the third scheduling offset threshold may be equal to the first scheduling offset threshold.

Some examples of the method, apparatus, and non-transitory computer-readable medium described herein may further include operations, features, means, or instructions for receiving, during a fourth TTI, a third control message that indicates a third scheduling offset for a third transmission, where the third scheduling offset does not satisfy the first scheduling offset threshold and transmitting an indication that the third scheduling offset does not satisfy the first scheduling offset threshold. In some examples of the method, apparatus, and non-transitory computer-readable medium described herein, transmitting the indication may include operations, features, means, or instructions for transmitting a feedback message associated with the third control message, the feedback message including a negative acknowledgement (NACK) indication.

Some examples of the method, apparatus, and non-transitory computer-readable medium described herein may further include operations, features, means, or instructions for monitoring for, or transmitting, the third transmission during a fifth TTI and receiving, during a sixth TTI, a fourth control message that indicates a fourth scheduling offset for a fourth transmission, where the fourth scheduling offset satisfies the second scheduling offset threshold, and where the first scheduling offset threshold may be changed to the second scheduling offset threshold based on the third scheduling offset not satisfying the first scheduling offset threshold.

Some examples of the method, apparatus, and non-transitory computer-readable medium described herein may further include operations, features, means, or instructions for receiving control signaling that enables or disables the UE to transmit the indication, change to the second scheduling offset threshold, or both, based on the third scheduling offset not satisfying the first scheduling offset threshold.

Some examples of the method, apparatus, and non-transitory computer-readable medium described herein may further include operations, features, means, or instructions for receiving, during a fourth TTI, a third control message that indicates a third scheduling offset for a first uplink transmission, where the third scheduling offset does not satisfy the first scheduling offset threshold and transmitting an indication that the third scheduling offset does not satisfy the first scheduling offset threshold.

In some examples of the method, apparatus, and non-transitory computer-readable medium described herein, transmitting the indication may include operations, features, means, or instructions for transmitting uplink control information (UCI) including the indication. Some examples of the method, apparatus, and non-transitory computer-readable medium described herein may further include operations, features, means, or instructions for receiving control signaling that enables or disables the UE to transmit the indication when the third scheduling offset does not satisfy the first scheduling offset threshold. In some examples of the method, apparatus, and non-transitory computer-readable medium described herein, the first scheduling offset threshold may be changed to the second scheduling offset threshold starting from the second TTI.

Some examples of the method, apparatus, and non-transitory computer-readable medium described herein may further include operations, features, means, or instructions for receiving, between the first TTI and the second TTI, a third control message that indicates a third scheduling offset for a third transmission, where the third scheduling offset may be greater than or equal to the first scheduling offset threshold and indicates that the third transmission may be scheduled in a fourth TTI that occurs after the first TTI in accordance with the third scheduling offset.

A method for wireless communications for a UE by an apparatus is described. The method may include receiving, during a first TTI and in accordance with a first communication configuration, a first control message indicating that a first transmission is scheduled in a second TTI that occurs after the first TTI and monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

An apparatus for wireless communications for a UE is described. The apparatus may include one or more memories storing processor executable code, and one or more processors coupled with the one or more memories. The one or more processors may individually or collectively be operable to execute the code to cause the apparatus to receive, during a first TTI and in accordance with a first communication configuration, a first control message indicating that a first transmission is scheduled in a second TTI that occurs after the first TTI and monitor for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

Another apparatus for wireless communications for a UE is described. The apparatus may include means for receiving, during a first TTI and in accordance with a first communication configuration, a first control message indicating that a first transmission is scheduled in a second TTI that occurs after the first TTI and means for monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

A non-transitory computer-readable medium storing code for wireless communications for a UE is described. The code may include instructions executable by one or more processors to receive, during a first TTI and in accordance with a first communication configuration, a first control message indicating that a first transmission is scheduled in a second TTI that occurs after the first TTI and monitor for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

Some examples of the method, apparatus, and non-transitory computer-readable medium described herein may further include operations, features, means, or instructions for receiving, during a third TTI in accordance with a third communication configuration, a second control message indicating that a second transmission may be scheduled in a fourth TTI that occurs after the third TTI based on a trigger event.

In some examples of the method, apparatus, and non-transitory computer-readable medium described herein, the trigger event includes a PDCCH skipping indication, an SSSG change indication, an end of burst indication, a BWP change indication, or any combination thereof. In some examples of the method, apparatus, and non-transitory computer-readable medium described herein, the trigger event includes an expiration of a timer and a duration of the timer may be reset based on receipt of each respective control message. In some examples of the method, apparatus, and non-transitory computer-readable medium described herein, the third communication configuration may be the same as to the first communication configuration.

Some examples of the method, apparatus, and non-transitory computer-readable medium described herein may further include operations, features, means, or instructions for receiving, during a third TTI and in accordance with the first communication configuration, a second control message indicating that a second transmission may be scheduled in a fourth TTI that occurs after the third TTI and transmitting an indication that the UE received the second control message in accordance with the first communication configuration based on the second transmission being associated with the second communication configuration.

In some examples of the method, apparatus, and non-transitory computer-readable medium described herein, transmitting the indication may include operations, features, means, or instructions for transmitting a feedback message associated with the second control message, the feedback message including a NACK indication.

Some examples of the method, apparatus, and non-transitory computer-readable medium described herein may further include operations, features, means, or instructions for monitoring for, or transmitting, the second transmission in the fourth TTI and in accordance with the second communication configuration and receiving, during a fifth TTI and in accordance with the second communication configuration, a third control message indicating a third transmission, where the first communication configuration may be changed to the second communication configuration based on the second transmission being associated with the second communication configuration.

Some examples of the method, apparatus, and non-transitory computer-readable medium described herein may further include operations, features, means, or instructions for receiving control signaling that enables or disables the UE to transmit the indication, change to the second communication configuration, or both, based on the second transmission being associated with the second communication configuration.

Some examples of the method, apparatus, and non-transitory computer-readable medium described herein may further include operations, features, means, or instructions for receiving, during a third TTI and in accordance with the first communication configuration, a second control message indicating that a first uplink transmission may be scheduled in a fourth TTI that occurs after the third TTI and transmitting an indication that the UE received the second control message in accordance with the first communication configuration based on the first uplink transmission being associated with the second communication configuration.

Some examples of the method, apparatus, and non-transitory computer-readable medium described herein may further include operations, features, means, or instructions for transmitting UCI including the indication. Some examples of the method, apparatus, and non-transitory computer-readable medium described herein may further include operations, features, means, or instructions for receiving control signaling that enables or disables the UE to transmit the indication when the first uplink transmission may be associated with the second communication configuration.

In some examples of the method, apparatus, and non-transitory computer-readable medium described herein, the first communication configuration may be changed to the second communication configuration starting from the second TTI.

Some examples of the method, apparatus, and non-transitory computer-readable medium described herein may further include operations, features, means, or instructions for receiving, between the first TTI and the second TTI, a second control message indicating that a second transmission may be scheduled in a fourth TTI that occurs after the first TTI, where the second control message may be received in accordance with the first communication configuration.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports automatic scheduling offset threshold in accordance with one or more aspects of the present disclosure.

FIG. 2 shows an example of a network architecture that supports automatic scheduling offset threshold in accordance with one or more aspects of the present disclosure.

FIG. 3 shows an example of a wireless communications system that supports automatic scheduling offset threshold in accordance with one or more aspects of the present disclosure.

FIG. 4 shows an example of a transmission scheduling timeline that supports automatic scheduling offset threshold in accordance with one or more aspects of the present disclosure.

FIG. 5 shows an example of a process flow that supports automatic scheduling offset threshold in accordance with one or more aspects of the present disclosure.

FIGS. 6 and 7 show block diagrams of devices that support automatic scheduling offset threshold in accordance with one or more aspects of the present disclosure.

FIG. 8 shows a block diagram of a communications manager that supports automatic scheduling offset threshold in accordance with one or more aspects of the present disclosure.

FIG. 9 shows a diagram of a system including a device that supports automatic scheduling offset threshold in accordance with one or more aspects of the present disclosure.

FIGS. 10 and 11 show flowcharts illustrating methods that support automatic scheduling offset threshold in accordance with one or more aspects of the present disclosure.

### DETAILED DESCRIPTION

Some wireless communication systems may indicate a quantity of zero or more transmission time intervals (TTIs) between a grant and a scheduled downlink or uplink transmission. For example, a physical downlink control channel (PDCCH) message may include a K0 value in downlink control information (DCI) to indicate a quantity of TTIs between the PDCCH and a scheduled physical downlink shared channel (PDSCH) message. Additionally, or alternatively, the PDCCH message may include a K2 value in the DCI to indicate a quantity of TTIs between the PDCCH and a scheduled physical uplink shared channel (PUSCH) message. In some systems, a minimum value for K0 and K2 may be zero (e.g., a PDCCH may schedule a PDSCH or PUSCH in the same TTI as the PDCCH). To receive the downlink or uplink transmission, a user equipment (UE) may buffer the total bandwidth of the bandwidth part (BWP) of the PDCCH message in case the PDCCH message indicates that K0 or K2 is zero. In some cases, buffering the total bandwidth of the BWP may increase power consumption at the UE. Additionally, K0 or K2 equal to zero may result in the UE decoding the PDCCH message relatively quickly to meet a PDSCH feedback timeline, which may further increase power consumption at the UE. Some other wireless communications systems implement a minimum scheduling offset for the K0 and K2 values (e.g., the minimum scheduling value may be offset to be greater than zero). Such other wireless communications systems may require the UE to receive configuration signaling indicating the different minimum scheduling offsets, as well as which minimum scheduling offset is active. However, since the UE may receive configuration signaling that indicates a zero scheduling offset value, the UE may still buffer the total bandwidth of the BWP of the PDCCH message.

The methods, systems, and techniques described herein enable a UE to automatically (e.g., without explicit configuration signaling) change a scheduling offset threshold from a first scheduling offset threshold to a second scheduling offset threshold. For example, the UE may use the first scheduling offset threshold prior to receiving a first PDCCH message, and then the UE may change to the second scheduling offset threshold based on receiving the first DCI in the first PDCCH message. The second scheduling offset threshold may be relatively smaller than the first scheduling offset threshold. For example, the first scheduling offset threshold may be a K0 value greater than zero and the second scheduling offset threshold may be a K0 value greater than or equal to zero.

Additionally, or alternatively, the UE may automatically adjust a communication configuration from a first communication configuration to a second communication configuration based on receiving the first DCI in the first PDCCH message. A communication configuration may be a transmission configuration (e.g., for transmitting messages), a reception configuration (e.g., for receiving messages), or both (e.g., for transmitting and receiving messages). For example, the first communication configuration may include a first quantity of antenna elements, a first quantity of spatial layers, a first performance criterion, or any combination thereof. Based on receiving the first DCI, the UE may adjust the first communication configuration to a second communication configuration that includes an increased quantity of antenna elements, an increased quantity of spatial layers, and an increased performance criterion.

In some examples, the UE may change to a third scheduling offset threshold, to a third communication configuration, or both, based on a trigger event. For example, the UE may change back to a relatively larger scheduling offset threshold than the second scheduling offset threshold or to a different communication configuration (e.g., that includes a fewer quantity of antenna elements, spatial layers, and a reduced performance criterion). The trigger event may be based on an indication from a network entity or an expiration of a timer at the UE (e.g., an inactivity timer).

Aspects of the disclosure are initially described in the context of wireless communications systems. Aspects of the disclosure are further illustrated by and described with reference to a network architecture, a transmission scheduling timeline, and a process flow. Aspects of the disclosure are further illustrated by and described with reference to apparatus diagrams, system diagrams, and flowcharts that relate to automatic scheduling offset threshold.

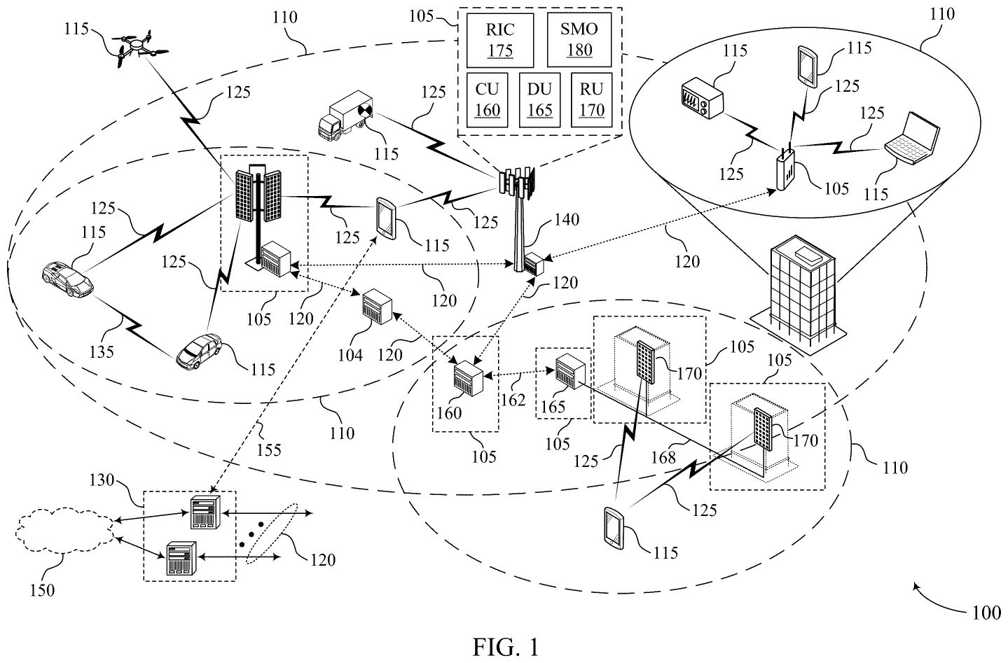

FIG. 1 shows an example of a wireless communications system 100 that supports automatic scheduling offset threshold in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication systems 100 may indicate a time duration between a grant and a scheduled downlink or uplink transmission. For example, a PDCCH message may include a K0 value in DCI to indicate a quantity of TTIs between the PDCCH and a scheduled PDSCH message. Additionally, or alternatively, the PDCCH message may include a K2 value in the DCI to indicate a quantity of TTIs between the PDCCH and a scheduled PUSCH message. In some systems, the minimum value for K0 and K2 may be zero (e.g., a PDCCH may schedule a PDSCH or PUSCH in the same TTI as the PDCCH). To receive the downlink or uplink transmission, a UE 115 may buffer the total bandwidth of the BWP of the PDCCH message in case the PDCCH message indicates that K0 or K2 is zero. In some cases, buffering the total bandwidth of the BWP may increase power consumption at the UE 115. Additionally, K0 or K2 equal to zero may result in the UE 115 decoding the PDCCH message relatively quickly to meet a PDSCH feedback timeline, which may further increase power consumption at the UE 115. Some other wireless communications systems 100 may implement a minimum scheduling offset for the K0 and K2 values (e.g., the minimum scheduling value may be offset to be greater than zero). Such other wireless communications systems 100 may require the UE 115 to receive configuration signaling indicating the different minimum scheduling offsets, as well as which minimum scheduling offset is active. However, since the UE 115 may receive configuration signaling that indicates a zero scheduling offset value, the UE 115 may still buffer the total bandwidth of the BWP of the PDCCH message.

The methods, systems, and techniques described herein enable a UE 115 to automatically (e.g., without explicit configuration signaling) change a scheduling offset threshold from a first scheduling offset threshold to a second scheduling offset threshold. For example, the UE 115 may use the first scheduling offset threshold prior to receiving a first PDCCH message, and then the UE 115 may change to the second scheduling offset threshold based on receiving the first DCI in the first PDCCH message. The second scheduling offset threshold may be relatively smaller than the first scheduling offset threshold. For example, the first scheduling offset threshold may be a K0 value greater than zero and the second scheduling offset threshold may be a K0 value greater than or equal to zero.

Additionally, or alternatively, the UE 115 may automatically adjust a communication configuration from a first communication configuration to a second communication configuration based on receiving the first DCI in the first PDCCH message. A communication configuration may be a transmission configuration (e.g., for transmitting messages), a reception configuration (e.g., for receiving messages), or both (e.g., for transmitting and receiving messages). For example, the first communication configuration may include a first quantity of antenna elements, a first quantity of spatial layers, a first performance criterion, or any combination thereof. Based on receiving the first DCI, the UE 115 may adjust the first communication configuration to a second communication configuration that includes an increased quantity of antenna elements, an increased quantity of spatial layers, and an increased performance criterion.

In some examples, the UE 115 may change to a third scheduling offset threshold, to a third communication configuration, or both, based on a trigger event. For example, the UE 115 may change back to a relatively larger scheduling offset threshold than the second scheduling offset threshold or to a different communication configuration (e.g., that includes a fewer quantity of antenna elements, spatial layers, and a reduced performance criterion). The trigger event may be based on an indication from a network entity or an expiration of a timer at the UE 115 (e.g., an inactivity timer).

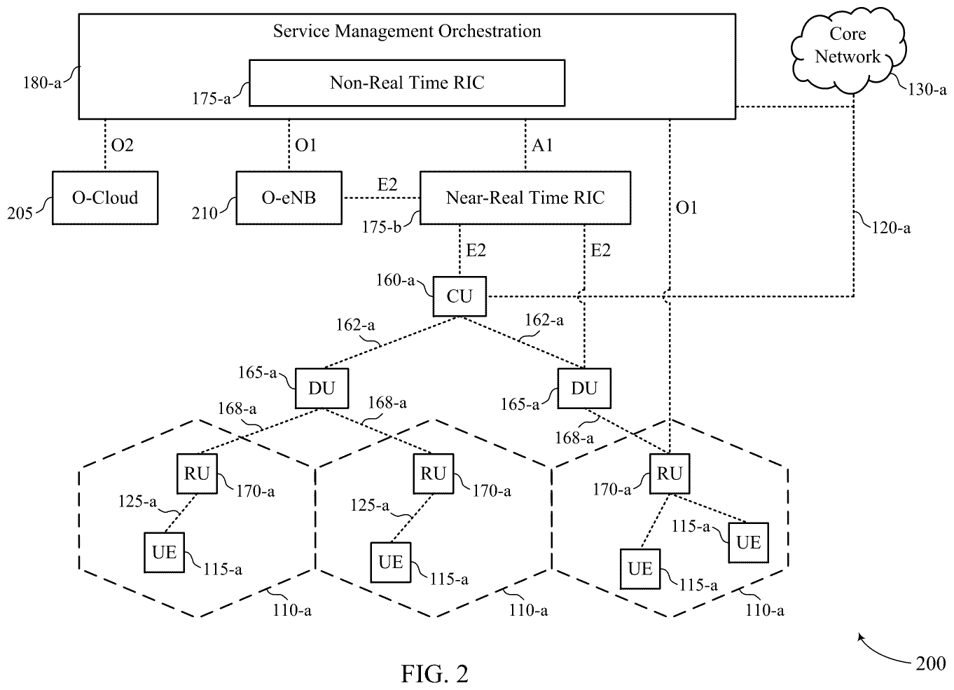

FIG. 2 shows an example of a network architecture 200 (e.g., a disaggregated base station architecture, a disaggregated RAN architecture) that supports automatic scheduling offset threshold in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

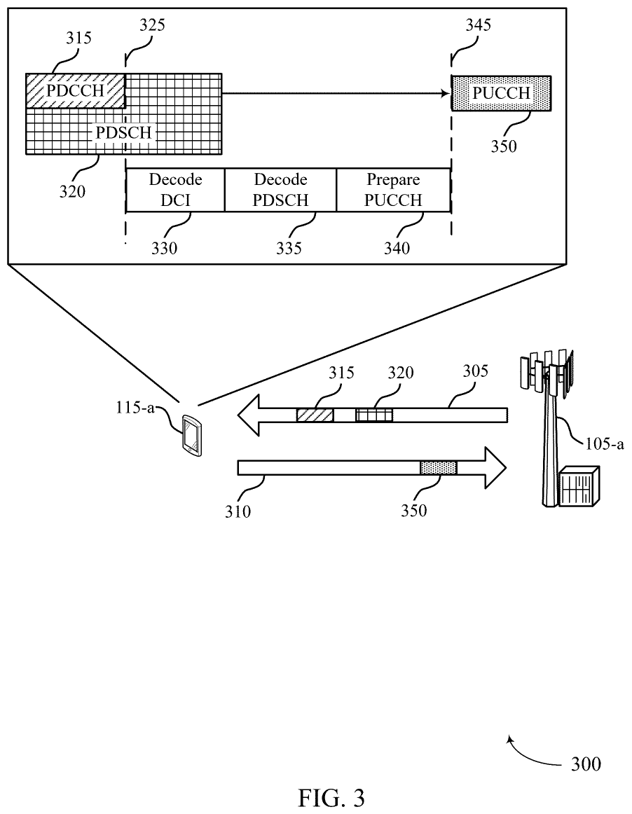

FIG. 3 shows an example of a wireless communications system 300 that supports automatic scheduling offset threshold in accordance with one or more aspects of the present disclosure. The wireless communications system 300 may implement aspects of or may be implemented by aspects of the wireless communications system 100 or the network architecture 200, as described with reference to FIGS. 1 and 2. For example, the wireless communications system 300 may include a UE 115-a and a network entity 105-a, which may be examples the corresponding devices described herein, including with reference to FIGS. 1 and 2.

In some examples, the UE 115-a may receive one or more downlink transmissions 305, transmit one or more uplink transmissions 310, or both. The one or more downlink transmissions 305 may include a PDCCH message 315 that schedules an uplink or downlink transmission. For example, the PDCCH message 315 may schedule a PDSCH message 320. In some examples, the UE 115-a may transmit an uplink message in response to receiving the PDCCH message 315 and the PDSCH message 320. For example, the UE 115-a may transmit a PUCCH message 350 in the one or more uplink transmissions 310. The PUCCH message 350 may include a feedback message, such as a positive acknowledgment (ACK) or negative acknowledgment (NACK). Additionally, or alternatively, the PDCCH message 315 may schedule a PUSCH message in some examples. In such examples, the UE 115-a may transmit an uplink message in the one or more uplink transmissions 310 using resources scheduled via the PUSCH message.

The PDCCH message 315 may schedule the PDSCH message 320 (or a PUSCH message) via DCI that indicates a K0 or K2 value. For example, the DCI may include a K0 value based on scheduling a downlink transmission (e.g., the PDSCH message 320), and the DCI may include a K2 value based on scheduling an uplink transmission (e.g., the PUSCH message). The K0 value may indicate a gap in a quantity of TTIs (e.g., slots) between a respective PDCCH message (e.g., a grant) and its scheduled downlink data transmission (e.g., PDSCH message). For example, a K0 value of 1 may indicate a PDCCH message received in a first TTI (e.g., slot 0) schedules a PDSCH message in the adjacent TTI (e.g., slot 1). The K2 value may indicate a gap in a quantity of TTIs (e.g., slots) between a respective PDCCH message its scheduled uplink data transmission (e.g., PUSCH message).

In some examples, the minimum value for K0, K2, or both, may be zero. A zero K0 or K2 value indicate that the PDCCH message 315 received in a first TTI schedules a downlink or uplink transmission in the same TTI. In some cases, the uplink or downlink transmission may occur concurrently with the PDCCH message 315 for at least a duration (e.g., the PDCCH message 315 and the PDSCH message 320 may overlap in time for at least a portion of the TTI). In other cases, the uplink or downlink transmission may occur after the PDCCH message 315, but within the same TTI (e.g., the PDSCH message 320 may occur after the PDCCH message 315 while in the same slot).

In some examples, the minimum K0 and K2 value may affect power consumption at the UE 115-a. For example, the PDCCH message 315 may include DCI that indicates a K0 or K2 value equal to zero (e.g., the minimum K0 and K2 value). The UE 115-a may buffer a total BWP bandwidth to receive the uplink or downlink transmission scheduled by the PDCCH message 315, which may increase power consumption at the UE 115-a. Otherwise, the UE 115-a may not receive one or more samples of the scheduled uplink or downlink transmission. For example, as seen in the wireless communications system 300, the UE 115-a may receive the PDCCH message 315 that schedules a PDSCH message 320 in accordance with a K0 value equal to zero. Since K0 is equal to zero, in this example, a portion of the PDSCH message 320 overlaps in time with the PDCCH message 315. Thus, to successfully decode the PDSCH message 320 (e.g., when the K0 value is zero) after receiving the PDCCH message 315, the UE 115-a may buffer the total bandwidth of the BWP, which may result in increased power consumption at the UE 115-a.

In some examples, the UE 115-a may have a certain duration to decode the DCI to meet a PDSCH feedback timeline. For example, the UE 115-a may receive the PDCCH message 315 at a first time 325. The PDCCH message 315 may indicate that the UE 115-a may use resources (e.g., time-frequency resources) to transmit one or more uplink transmissions (e.g., feedback for the PDSCH message 320) at a second time 345. The duration between the first time 325 and the second time 345 may be a process procedure timeline (e.g., N1).

During the process procedure timeline, the UE 115-a may perform a first decoding operation 330 to decode the DCI included in the PDCCH message 315 (e.g., to obtain the grant information). As described herein, the DCI may include an indication of a K0 value, a K2 value, or both. For example, as illustrated in FIG. 3, the DCI may indicate that K0 is zero. Based on decoding the DCI and obtaining the K0 value (e.g., or K2 value), the UE 115-a may perform a second decoding operation 335. For example, the UE 115-a may decode the PDSCH message 320 scheduled by the PDCCH message 315. In response to performing the second decoding operation 335, the UE 115-a may perform a response operation 340. In some examples, the PDSCH message 320 may include data, and the UE 115-a may transmit a PUCCH message 350 in response to the data. For example, the PUCCH message 350 may include a feedback message (e.g., a HARQ message) corresponding to the PDSCH message 320.

In some cases, performing the first decoding operation 330, the second decoding operation 335, and the response operation 340 to meet the process procedure timeline may increase power consumption for the UE 115-a. For example, the UE 115-a may have less time to perform the second decoding operation 335 and the response operation 340 based on a K0 value of zero. In some examples, a minimum K0 value of zero may prevent the UE 115-a from powering off one or more RF components on non-scheduling carriers, or may prevent the UE 115-a from entering a power-efficient (e.g., power saving) state in case of cross-carrier scheduling.

In some examples, a minimum scheduling offset for K0 and K2 may increase the minimum K0 or K2 value to a value greater than 0. In other wireless communications systems, the minimum scheduling offset values may be configured per BWP, and the DCI may indicate which value offset is in effect. For example, in other systems, a network entity may signal each time the minimum scheduling offset is changed. However, the UE may still buffer the total BWP bandwidth (e.g., which may result in increased power consumption) to receive scheduled transmissions because the network entity may transmit a PDCCH with DCI indicating a zero K0 value.

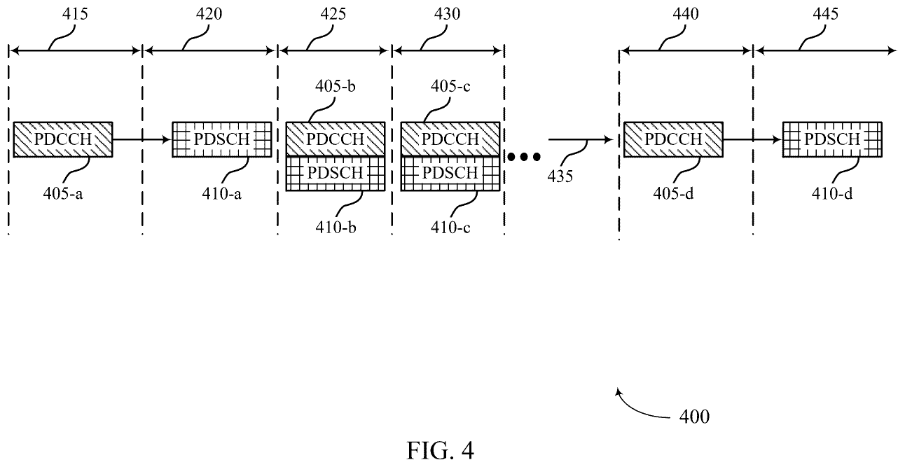

The systems, methods, and techniques described herein enable the UE 115-a to automatically change the minimum scheduling offset while retaining power saving advantages. As described further with reference to FIG. 4, the UE 115-a may change from a first scheduling offset threshold to a second scheduling offset threshold after receiving a first DCI (e.g., in the PDCCH message 315). Additionally, or alternatively, the UE 115-a may adjust a communication configuration after receiving the first DCI. For example, the UE 115-a may receive the first DCI using a first quantity of antenna elements, spatial layers (e.g., MIMO layers), or a performance criterion (e.g., reduced performance requirements) and then change to a second quantity of antenna elements, spatial layers, or performance criterion (e.g., increased performance requirements). A respective communication configuration may be a transmission configuration (e.g., for transmitting messages), a reception configuration (e.g., for receiving messages), or both (e.g., for transmitting and receiving messages). Automatically changing the minimum scheduling offset may enable the UE 115-a to consume less power compared to other wireless communications systems. For example, the UE 115-a may not buffer the entire BWP bandwidth based on receiving the first DCI in accordance with the first scheduling offset threshold. Additionally, the UE 115-a may receive and process less transmissions based on automatically changing the scheduling offset threshold (e.g., compared to other systems that may signal for each change in the scheduling offset).

FIG. 4 shows an example of a transmission scheduling timeline 400 that supports automatic scheduling offset threshold in accordance with one or more aspects of the present disclosure. In the example of FIG. 4, a network entity may transmit a one or more PDCCH messages 405 that may schedule one or more PDSCH messages 410 for a UE to receive. The network entity and the UE may be examples of a network entity 105 and a UE 115 as described herein. Although FIG. 4 illustrates one or more PDCCH messages 405 scheduling one or more PDSCH messages 410 via K0 values, it may be understood that the techniques described herein may apply to one or more PDCCH messages 405 scheduling one or more PUSCH resources via K2 values.

In some examples, the UE may receive a first PDCCH message 405-a during a first duration 415. In some cases, the first duration 415 may correspond to a first TTI (e.g., a first slot). The UE may decode the first PDCCH message 405-a and may obtain first DCI from the first PDCCH message 405-a. The first DCI may indicate a K0 value, a K2 value, or both. In some examples, the K0 or K2 value may satisfy a first scheduling offset threshold. For example, the first scheduling offset threshold may be a value greater than zero based on the UE operating in a DRX-on duration (e.g., K0>0 or K2>0). Based on receiving the first DCI, the UE may change (e.g., automatically change) from the first scheduling offset threshold to a second scheduling offset threshold. In some examples, the second scheduling offset threshold may be smaller than the first scheduling offset threshold. For example, the first scheduling offset threshold may be 5 and the second scheduling offset threshold may be 3.

In the example of FIG. 4, the UE may change to the second scheduling offset threshold based on receiving the first DCI and monitor for the scheduled first PDSCH message 410-a during a second duration 420. In some cases, a third duration 425 may overlap with the second duration 420. In such cases, the second PDCCH message 405-b may be in the same slot as the first PDSCH message 410-a. In other cases, the third duration 425 may not overlap with the second duration 420 (e.g., the third duration 425 may occur after the second duration 420). In some examples, the first PDSCH message 410-a may occur a quantity of one or more TTIs after the first PDCCH message 405-a based on the scheduling offset indicated in the first DCI. For example, the first DCI may indicate K0=1 and the UE may receive the first PDSCH message 410-a in an adjacent slot to the first PDCCH message 405-a. In another example, the first DCI may indicate K0=3 and the UE may receive the first PDSCH message 410-a 3 slots after the slot of the first PDCCH message 405-a.

In some examples, the UE may receive a second PDCCH message 405-b in the third duration 425. The second PDCCH message 405-b may include a second DCI indicating a second PDSCH message 410-b that occurs in accordance with the second scheduling offset threshold. For example, the second DCI may indicate K0=0 for the second PDSCH message 410-b. In some cases, the second PDCCH message 405-b may occur in a TTI (e.g., slot) that partially overlaps, or is the same as, the TTI of the first PDSCH message 410-a. For example, the second duration 420 may be the same as the third duration 425. In some examples, the UE may receive additional PDCCH messages 405 scheduling additional PDSCH messages 410 that satisfy the second scheduling offset threshold. For example, the UE may receive a third PDCCH message 405-c that includes a third DCI in a fourth duration 430. The third DCI may schedule a third PDSCH message 410-c that occurs in accordance with the second scheduling offset threshold. For example, the third PDSCH message 410-c may occur during the fourth duration 430 (e.g., at the same time as the third PDCCH message 405-c).

In some examples, the UE may change the scheduling offset threshold in response to a trigger event 435 (e.g., adjust the scheduling offset back to a larger value). For example, the UE may change the scheduling offset threshold based on receiving explicit signaling from the network entity. In some examples, the UE may change the scheduling offset threshold based on receiving a PDCCH skipping indication (e.g., an indication to skip monitoring for a PDCCH in accordance with a power saving mode), an indication of a change in a search space set group (SSSG) (e.g., change from a first SSSG to a second SSSG), an end of burst indication (e.g., an end of a burst of PDCCH transmissions), a BWP change indication (e.g., change from a first BWP to a second BWP), or any combination thereof.

Additionally, or alternatively, the UE may change the scheduling offset threshold after a timer expires. In some examples, the timer may be a DRX inactivity timer. For example, the timer may reset or extend based on receiving a PDCCH message 405. After the trigger event 435, the UE may change to a third scheduling offset threshold. For example, the third scheduling offset threshold may be larger than the second scheduling offset threshold. In some cases, the third scheduling offset threshold is equal to the first scheduling offset threshold. In some examples, different values for the scheduling offset may be specified, configured, or signaled. For example, the UE may receive configurating signaling indicating different scheduling offset values (e.g., via a MAC-CE).

In some examples, the UE may receive a fourth PDCCH message 405-d during a fifth duration 440 (e.g., a fifth TTI) that occurs after the trigger event 435. For example, the UE may receive the fourth PDCCH message 405-d after changing to the third scheduling offset threshold. In such examples, fourth DCI in the fourth PDCCH message 405-d may indicate a scheduling offset that satisfies the third scheduling offset threshold. For example, the fourth DCI may indicate a fourth PDSCH message 410-d that occurs in a sixth duration 445. The UE may change to a fourth scheduling offset threshold (e.g., the second scheduling offset threshold) based on receiving the fourth DCI and may monitor for the fourth PDSCH message 410-d in the sixth duration 445 in accordance with the scheduling offset.

In some examples, the UE may not receive (e.g., miss) the first PDCCH message 405-a. In such examples, the network entity may expect the UE to use the second scheduling offset threshold. For example, the network entity may be unaware the UE did not receive the first PDCCH message 405-a and may assume the UE has changed to the second scheduling offset threshold. Based on missing the first PDCCH message 405-a, the UE may detect a downlink grant (e.g., the second PDCCH message 405-b) with a scheduling offset smaller than the first scheduling offset threshold. In some cases, the UE may transmit an indication that the scheduling offset is too small (e.g., an indication that the scheduling offset does not satisfy the expected scheduling offset threshold). The UE may transmit the indication via explicit signaling or implicitly via a feedback message (e.g., via a NACK). Additionally, or alternatively, the UE may switch to the second scheduling offset threshold based on detecting that the scheduling offset indicated in the second PDCCH message 405-b does not satisfy the first scheduling offset threshold. The UE may signal the indication, switch to the second offset threshold, or both, based on receiving configuration signaling from the network entity.

In some cases, the UE may detect an uplink grant with a scheduling offset smaller than the first scheduling offset threshold (e.g., that does not satisfy the first scheduling offset threshold). In such cases, the UE may signal to the network entity that the scheduling offset does not satisfy the first scheduling threshold (e.g., is too small). In some examples, the UE may transmit the indication via uplink control information (UCI) or other uplink signaling in place of the scheduled uplink transmission. In other examples, the UE may transmit the indication in another upcoming uplink transmission (e.g., in an upcoming periodically scheduled transmission). In some examples, the UE may signal the indication based on receiving configuration signaling from the network entity that enables the UE to transmit the indication in place of an uplink transmission.

In some examples, the UE may change to the second scheduling offset threshold starting from the slot indicated in the first DCI. For example, the UE may change to the second scheduling offset after K0, or K2, TTIs (e.g., after K0 slots or after K2 slots). Additionally, or alternatively, the UE may not expect another PDCCH message 405 to schedule an uplink or downlink transmission to arrive between the first PDCCH message 405-a and the first scheduled transmission (e.g., the first PDSCH message 410-a). In some examples, the UE may be scheduled with such a PDCCH message 405 based on the scheduling offset indicated by the PDCCH message 405 being greater than or equal to the first scheduling offset (e.g., if the PDCCH message 405 indicates a K0 or K2 value that satisfies the first scheduling offset threshold).

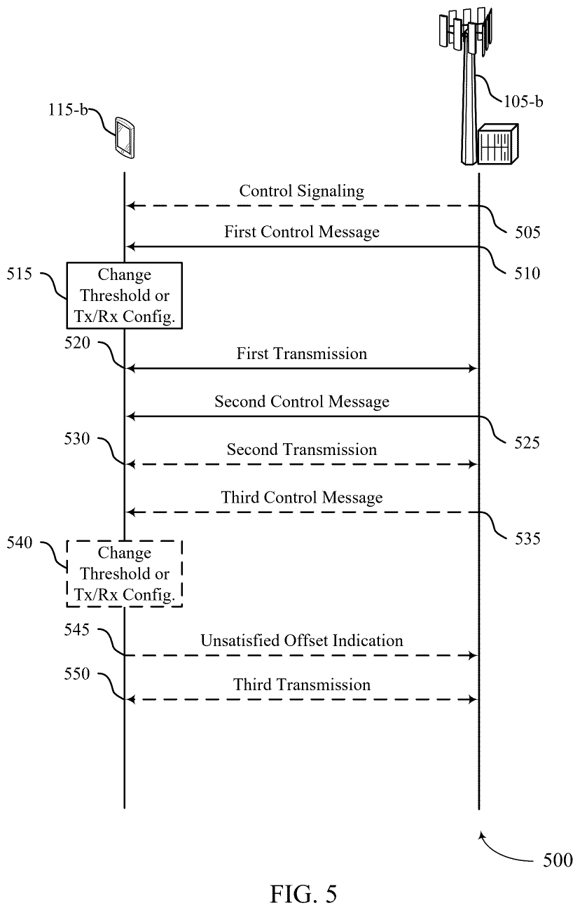

As described further with reference to FIG. 5, the UE may change from a first communication configuration to a second communication configuration in addition to, or in place of, changing to the second scheduling offset threshold. For example, the UE may receive the first PDCCH message 405-a in accordance with the first communication configuration (e.g., a reception configuration) and change to a second communication configuration after receiving the first DCI. The first communication configuration may include a first quantity of antenna elements, spatial layers, performance criterion, or any combination thereof. After changing to the second communication configuration, the UE may receive the first PDSCH message 410-a (and subsequent PDCCH message 405-b and PDCCH message 405-c) in accordance with the second communication configuration.

The second communication configuration may include an increased quantity of antenna elements, spatial layers, and performance criterion relative to the first communication configuration. For example, the UE may receive the first PDCCH message 405-a in accordance with a first maximum quantity of MIMO layers (e.g., two maximum layers) and then receive the first PDSCH message 410-a in accordance with an increased maximum quantity of MIMO layers (e.g., more than two layers). In another example, the UE may receive the first PDCCH message 405-a in accordance with a first (e.g., relatively reduced) performance criterion and then receive the first PDSCH message 410-a in accordance with a second (e.g., relatively increased, or nominal) performance criterion. After the trigger event 435, the UE may change to a third communication configuration (e.g., which may be the same as the first communication configuration).

FIG. 5 shows an example of a process flow 500 that supports automatic scheduling offset threshold in accordance with one or more aspects of the present disclosure. The process flow 500 may be implemented by aspects of the wireless communications systems 100 and 300, as well as the network architecture 200. For example, a UE 115-b and a network entity 105-b, which may be examples of a UE 115 or a network entity 105 as described herein, may perform aspects of the process flow 500. In the following description of the process flow 500, operations performed by the UE 115-b and the network entity 105-b may be performed in a different order than is shown. Some operations may be omitted from the process flow 500, and other operations may be added to the process flow 500. Further, although some operations or signaling may be shown to occur at different times for discussion purposes, these operations may occur at the same time.

At 505, the UE 115-b may receive control signaling that enables or disables the UE 115-b to transmit an indication of a scheduling offset not satisfying a scheduling offset threshold. In some examples, the control signaling may enable or disable the UE 115-b to transmit the indication using resources previously allocated for another uplink transmission. For example, the control signaling may enable or disable the UE 115-b to transmit the indication in place of an uplink transmission scheduled by a PDCCH resource or another upcoming uplink transmission (e.g., a periodically scheduled transmission). Additionally, or alternatively, the control signaling may enable or disable the UE 115-b to change from a first scheduling offset threshold to a second scheduling offset threshold based on receiving DCI that indicates a scheduling offset that does not satisfy the first scheduling offset threshold.

At 510, the UE 115-b may receive a first control message during a first TTI (e.g., a first slot). The first control message may indicate a first scheduling offset for a first transmission. In some examples, the first scheduling offset may be K0, and the first transmission may be a downlink transmission (e.g., PDSCH). In other examples, the first scheduling offset may be K2 and the first transmission may be an uplink transmission (e.g., PUSCH). The first scheduling offset may satisfy a first scheduling offset threshold at the UE 115-b and may indicate that the first transmission is scheduled in a second TTI (e.g., a second slot) that occurs after the first TTI in accordance with the first scheduling offset. In some cases, the second TTI occurs immediately after the first TTI (e.g., the first slot is adjacent to the second slot). In other cases, the second TTI may occur a duration after the first TTI (e.g., there may be one or more slots between the first slot and the second slot).

Additionally, or alternatively, the UE 115-b may receive the first control message during the first TTI in accordance with a first communication configuration (a reception (Rx) configuration or transmission (Tx) configuration). For example, the UE 115-b may receive the first control message with a first quantity of antenna elements, a first quantity of spatial layers, a first performance criterion, or any combination thereof.

At 515, the UE 115-b may change to the second scheduling offset threshold based on receipt of the first control message. For example, the UE 115-b may apply the second scheduling offset threshold starting from the second TTI indicated in the first DCI (e.g., starting after K0, or K2, slots). In some examples, the second scheduling offset threshold may be less than the first scheduling offset threshold. For example, the first scheduling offset threshold may be satisfied by any value greater than zero and the second scheduling offset threshold may be satisfied by any value greater than or equal to zero. Additionally, or alternatively, the UE 115-b may change to a second communication configuration based on receipt of the first control message. In some examples, the second communication configuration may adjust the first quantity of antenna elements, the first quantity of spatial layers, the first performance criterion, or any combination thereof, relative to the first communication configuration. For example, the UE 115-b may increase the first quantity of antenna elements (e.g., activate more antenna elements), increase the first quantity of spatial layers (e.g., increase a quantity of maximum MIMO layers), or increase the performance criterion (e.g., for nominal performance compared to reduced performance in the first communication configuration).

At 520, the UE 115-b may monitor for, or transmit, the first transmission during the second TTI. For example, the UE 115-b may monitor for the first transmission based on the first control message indicating the first scheduling offset (e.g., K0) for a first PDSCH. The UE 115-b may receive the first PDSCH based on monitoring for the first PDSCH. If the first control message indicates the first scheduling offset (e.g., K2) for a first PUSCH, the UE 115-b may transmit the first transmission during the second TTI. In some examples, the UE 115-b may monitor for, or transmit, the first transmission during the second TTI in accordance with the second communication configuration. For example, the UE 115-b may monitor for the first transmission in accordance with a second reception configuration, or transmit the first transmission in accordance with a second transmission configuration. In some examples, the second communication configuration may include both the second reception configuration and the second transmission configuration.

At 525, the UE 115-b may receive a second control message (e.g., a second PDCCH) during a third TTI (e.g., a third slot). In some examples, the third TTI may overlap with at least a portion of the second TTI or be the same as the second TTI. For example, the third slot may overlap with the second slot or be the same slot. In other examples, the third TTI may occur after the second TTI (e.g., the third slot may occur a quantity of slots after the second slot or be adjacent to the second slot). The second control message may indicate a second scheduling offset (e.g., K0, K2, or both) for a second transmission (e.g., PDSCH or PUSCH). In some examples, the second scheduling offset may satisfy the second scheduling offset threshold.

At 530, the UE 115-b may monitor for, or transmit, the second transmission during a TTI indicated in the second DCI of the second control message. For example, the UE 115-b may monitor for the second transmission based on the second control message indicating the second scheduling offset (e.g., K0) for a second PDSCH. In some examples, the indicated TTI may occur after the third TTI (e.g., a quantity of slots after the third TTI). In other examples, the indicated TTI may be the same as the second TTI. For example, the second transmission may occur at the same time as the second control message (e.g., the UE 115-b may buffer samples of the second transmission while receiving the second PDCCH). In some cases, the second transmission may occur after the second control message, but in the same TTI. For example, the second PDCCH may span a first portion of the second slot and the second transmission may span a second portion of the second slot. The UE 115-b may receive the second PDSCH based on monitoring for the second PDSCH. If the second control message indicates the second scheduling offset (e.g., K2) for a second PUSCH, the UE 115-b may transmit the second transmission during the indicated TTI. Additionally, or alternatively, the UE 115-b may monitor for, or transmit, the second transmission in accordance with the second communication configuration.

At 535, the UE 115-b may receive a third control message that indicates a third scheduling offset for a third transmission during a fourth TTI (e.g., a fourth slot). The third scheduling offset may satisfy a third scheduling offset threshold and may indicate that the third transmission is scheduled in a fifth TTI (e.g., a fifth slot) that occurs after the fourth TTI in accordance with the third scheduling offset. In some examples, the third scheduling offset threshold may be greater than the second scheduling offset threshold. For example, the third scheduling offset threshold may be equal to the first scheduling offset threshold.

At 540, the UE 115-b may change from the second scheduling offset threshold to the third scheduling offset threshold based on a trigger event. In some examples, the trigger event may be an indication received by the UE 115-b. For example, the UE 115-b may receive explicit signaling from the network entity 105-b to change to the third scheduling offset threshold. Additionally, or alternatively, the UE 115-b may receive a PDCCH skipping indication (e.g., an indication to skip monitoring for a PDCCH in accordance with a power saving mode), an SSSG change indication (e.g., an indication to change to a different SSSG), an end of burst indication (e.g., an end of a burst of PDCCH transmissions), a BWP change indication, or any combination thereof. In other examples, the trigger event may be an expiration of a timer. For example, the timer may be a DRX inactivity timer. In some examples, a duration of the timer may reset or be extended based on receipt of each respective control message (e.g., each received PDCCH may reset the timer duration, extend the timer duration, or both).

In some examples, the UE 115-b may change from the second communication configuration to a third communication configuration based on the trigger event. In some examples, the third communication configuration may be adjusted relative to the second communication configuration. For example, the third communication configuration may include a decreased quantity of antenna elements, a decreased quantity of spatial layers, and a relaxed performance criterion relative to the second communication configuration. In some examples, the third communication configuration may the same as the first communication configuration.

In some cases, the UE 115-b may receive the third control message during the fourth TTI, and the third control message may indicate a third scheduling offset that does not satisfy the first scheduling offset threshold. For example, the UE 115-b may not receive the first control message and may not change to the second scheduling offset threshold (e.g., because the UE 115-b did not receive the first DCI). In such cases, the network entity 105-b may transmit the third control message (e.g., or the second control message) with a third scheduling offset that satisfies the second scheduling offset threshold, but may not satisfy the first scheduling offset threshold. For example, the network entity 105-b may assume the UE 115-b received the first control message and changed to the second scheduling offset threshold. In some other examples, the UE 115-b may not receive the first control message and receive the third control message (e.g., or the second control message) in accordance with the first communication configuration rather than the second communication configuration.

At 545, the UE 115-b may transmit an indication that the third scheduling offset does not satisfy the first scheduling offset threshold. Additionally, or alternatively, the UE 115-b may transmit an indication that the UE 115-b received the third control message (e.g., or the second control message) in accordance with the first communication configuration based on the transmission being associated with the second communication configuration. For example, the network entity 105-b may assume that the UE 115-b would receive the transmission in accordance with the second communication configuration. In some examples, the indication may be a feedback message (e.g., a HARQ message) indicating a NACK. In other examples, the UE 115-b may transmit the indication via UCI or other uplink signaling in place of a scheduled uplink transmission (e.g., a PUSCH scheduled by the third PDCCH). For example, the UE 115-b may transmit the indication via UCI based on the third control message indicating the third scheduling offset for an uplink transmission (e.g., the third DCI includes a K2 value for a PUSCH transmission).

Additionally, or alternatively, at 550, the UE 115-b may monitor for, or transmit, the third transmission during a fifth TTI. In some examples, the fifth TTI occurs at the same time as the fourth TTI (e.g., the third PDCCH schedules a transmission in the same slot). For example, the UE 115-b may monitor for a third PDSCH based on the third control message scheduling a downlink transmission. The UE 115-b may transmit the third transmission based on the PDCCH scheduling an uplink transmission.

In some examples, the UE 115-b may change to the second scheduling offset threshold based on the third scheduling offset not satisfying the first scheduling offset threshold. For example, the UE 115-b may receive the third control message indicating the third scheduling offset that does not satisfy the first scheduling offset threshold and, in response, change to the second scheduling offset threshold. Additionally, or alternatively, the UE 115-b may change to the second communication configuration based on receiving the third control message (e.g., or the second control message) in accordance with the first communication configuration. As described herein, the UE 115-b may receive control signaling that enables or disables the UE 115-b to transmit the indication, change to the second scheduling offset threshold, change to the second communication configuration, or any combination thereof.

In some cases, the UE 115-b may receive the third control message between the first TTI and the second TTI. In such cases, the third control message may indicate a scheduling offset for the third transmission that may be greater than, or equal to, the first scheduling offset threshold. That is, the scheduling offset may satisfy the first scheduling offset threshold based on the UE 115-b receiving the third control message that indicates the third transmission between the first TTI and the second TTI (e.g., before the UE 115-b changes to the second scheduling offset threshold). Additionally, or alternatively, the UE 115-b may receive the third control message in accordance with the first communication configuration. In some other cases, the UE 115-b may not expect to receive a control message to schedule a transmission to arrive at the UE 115-b between the first control message and the first transmission.

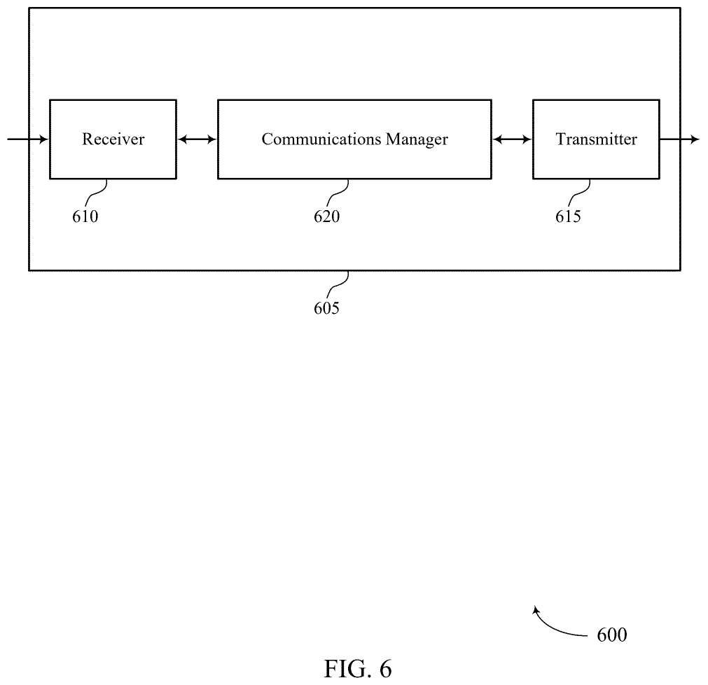

FIG. 6 shows a block diagram 600 of a device 605 that supports automatic scheduling offset threshold in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to automatic scheduling offset threshold). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to automatic scheduling offset threshold). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of automatic scheduling offset threshold as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications for a UE in accordance with examples as disclosed herein. For example, the communications manager 620 is capable of, configured to, or operable to support a means for receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset. The communications manager 620 is capable of, configured to, or operable to support a means for monitoring for, or transmitting, the first transmission during the second TTI. The communications manager 620 is capable of, configured to, or operable to support a means for receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

Additionally, or alternatively, the communications manager 620 may support wireless communications for a UE in accordance with examples as disclosed herein. For example, the communications manager 620 is capable of, configured to, or operable to support a means for receiving, during a first TTI and in accordance with a first communication configuration, a first control message indicating that a first transmission is scheduled in a second TTI that occurs after the first TTI. The communications manager 620 is capable of, configured to, or operable to support a means for monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, and more efficient utilization of communication resources, among other examples.

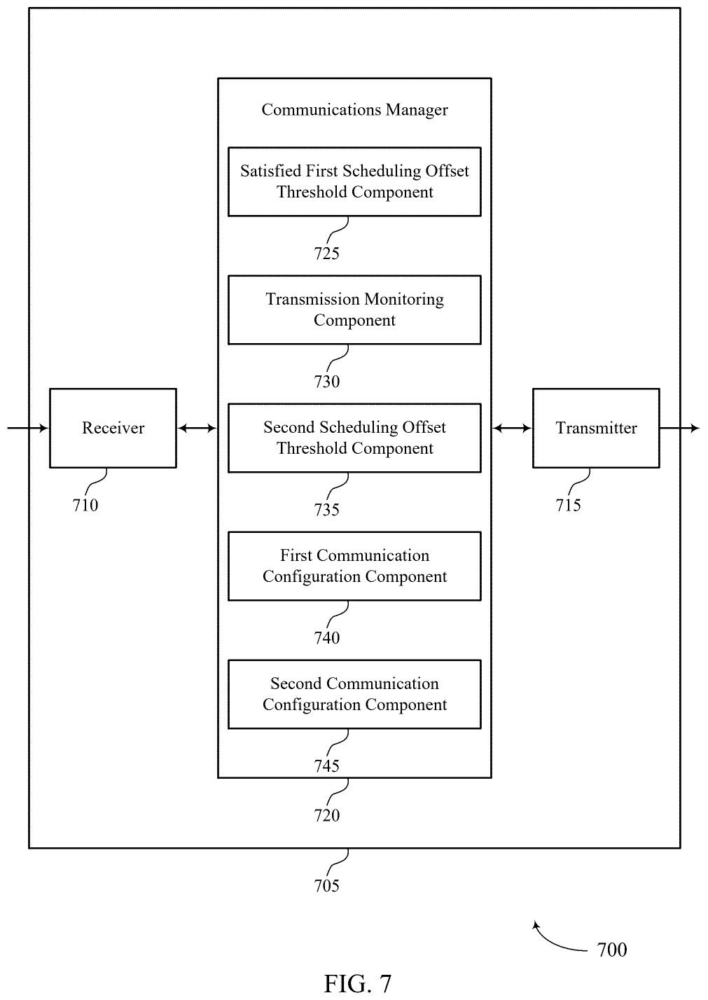

FIG. 7 shows a block diagram 700 of a device 705 that supports automatic scheduling offset threshold in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to automatic scheduling offset threshold). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to automatic scheduling offset threshold). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of automatic scheduling offset threshold as described herein. For example, the communications manager 720 may include a satisfied first scheduling offset threshold component 725, a transmission monitoring component 730, a second scheduling offset threshold component 735, a first communication configuration component 740, a second communication configuration component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications for a UE in accordance with examples as disclosed herein. The satisfied first scheduling offset threshold component 725 is capable of, configured to, or operable to support a means for receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset. The transmission monitoring component 730 is capable of, configured to, or operable to support a means for monitoring for, or transmitting, the first transmission during the second TTI. The second scheduling offset threshold component 735 is capable of, configured to, or operable to support a means for receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

Additionally, or alternatively, the communications manager 720 may support wireless communications for a UE in accordance with examples as disclosed herein. The first communication configuration component 740 is capable of, configured to, or operable to support a means for receiving, during a first TTI and in accordance with a first communication configuration, a first control message indicating that a first transmission is scheduled in a second TTI that occurs after the first TTI. The second communication configuration component 745 is capable of, configured to, or operable to support a means for monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

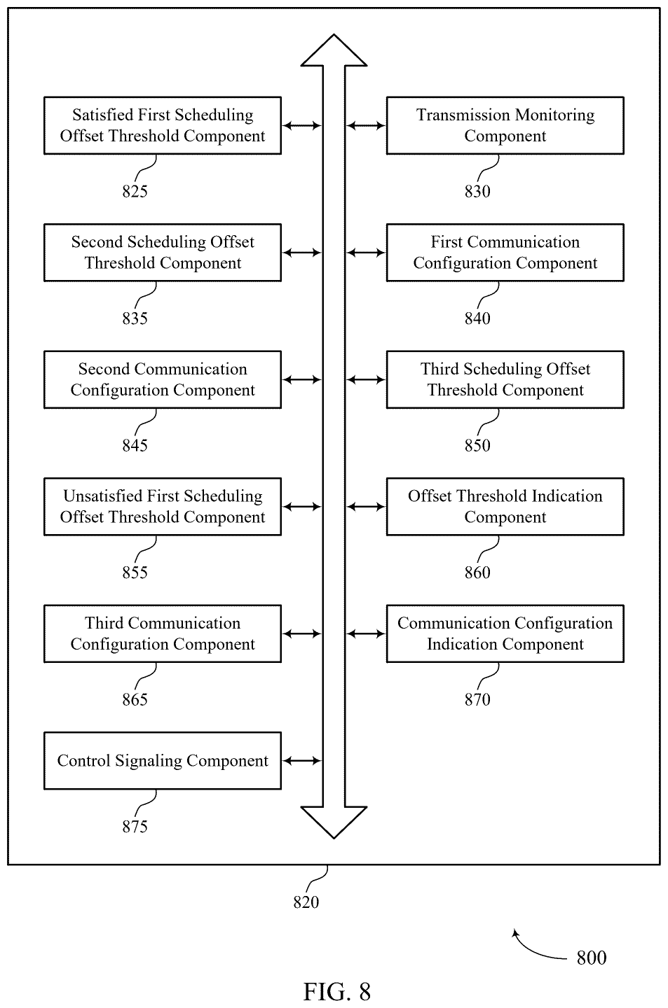

FIG. 8 shows a block diagram 800 of a communications manager 820 that supports automatic scheduling offset threshold in accordance with one or more aspects of the present disclosure. The communications manager 820 may be an example of aspects of a communications manager 620, a communications manager 720, or both, as described herein. The communications manager 820, or various components thereof, may be an example of means for performing various aspects of automatic scheduling offset threshold as described herein. For example, the communications manager 820 may include a satisfied first scheduling offset threshold component 825, a transmission monitoring component 830, a second scheduling offset threshold component 835, a first communication configuration component 840, a second communication configuration component 845, a third scheduling offset threshold component 850, an unsatisfied first scheduling offset threshold component 855, an offset threshold indication component 860, a third communication configuration component 865, a communication configuration indication component 870, a control signaling component 875, or any combination thereof. Each of these components, or components or subcomponents thereof (e.g., one or more processors, one or more memories), may communicate, directly or indirectly, with one another (e.g., via one or more buses).

The communications manager 820 may support wireless communications for a UE in accordance with examples as disclosed herein. The satisfied first scheduling offset threshold component 825 is capable of, configured to, or operable to support a means for receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset. The transmission monitoring component 830 is capable of, configured to, or operable to support a means for monitoring for, or transmitting, the first transmission during the second TTI. The second scheduling offset threshold component 835 is capable of, configured to, or operable to support a means for receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

In some examples, the third scheduling offset threshold component 850 is capable of, configured to, or operable to support a means for receiving, during a fourth TTI, a third control message that indicates a third scheduling offset for a third transmission, where the third scheduling offset satisfies a third scheduling offset threshold and indicates that the third transmission is scheduled in a fifth TTI that occurs after the fourth TTI in accordance with the third scheduling offset, and where the second scheduling offset threshold is changed to the third scheduling offset threshold based on a trigger event. In some examples, the trigger event includes a PDCCH skipping indication, a SSSG change indication, an end of burst indication, a BWP change indication, or any combination thereof. In some examples, the trigger event includes an expiration of a timer. In some examples, a duration of the timer is reset based on receipt of each respective control message. In some examples, the third scheduling offset threshold is equal to the first scheduling offset threshold.

In some examples, the unsatisfied first scheduling offset threshold component 855 is capable of, configured to, or operable to support a means for receiving, during a fourth TTI, a third control message that indicates a third scheduling offset for a third transmission, where the third scheduling offset does not satisfy the first scheduling offset threshold. In some examples, the offset threshold indication component 860 is capable of, configured to, or operable to support a means for transmitting an indication that the third scheduling offset does not satisfy the first scheduling offset threshold. In some examples, to support transmitting the indication, the offset threshold indication component 860 is capable of, configured to, or operable to support a means for transmitting a feedback message associated with the third control message, the feedback message including a NACK indication.

In some examples, the transmission monitoring component 830 is capable of, configured to, or operable to support a means for monitoring for, or transmitting, the third transmission during a fifth TTI. In some examples, the second scheduling offset threshold component 835 is capable of, configured to, or operable to support a means for receiving, during a sixth TTI, a fourth control message that indicates a fourth scheduling offset for a fourth transmission, where the fourth scheduling offset satisfies the second scheduling offset threshold, and where the first scheduling offset threshold is changed to the second scheduling offset threshold based on the third scheduling offset not satisfying the first scheduling offset threshold. In some examples, the control signaling component 875 is capable of, configured to, or operable to support a means for receiving control signaling that enables or disables the UE to transmit the indication, change to the second scheduling offset threshold, or both, based on the third scheduling offset not satisfying the first scheduling offset threshold.

In some examples, the unsatisfied first scheduling offset threshold component 855 is capable of, configured to, or operable to support a means for receiving, during a fourth TTI, a third control message that indicates a third scheduling offset for a first uplink transmission, where the third scheduling offset does not satisfy the first scheduling offset threshold. In some examples, the offset threshold indication component 860 is capable of, configured to, or operable to support a means for transmitting an indication that the third scheduling offset does not satisfy the first scheduling offset threshold. In some examples, to support transmitting the indication, the offset threshold indication component 860 is capable of, configured to, or operable to support a means for transmitting uplink control information including the indication.

In some examples, the control signaling component 875 is capable of, configured to, or operable to support a means for receiving control signaling that enables or disables the UE to transmit the indication when the third scheduling offset does not satisfy the first scheduling offset threshold. In some examples, the first scheduling offset threshold is changed to the second scheduling offset threshold starting from the second TTI.

In some examples, the satisfied first scheduling offset threshold component 825 is capable of, configured to, or operable to support a means for receiving, between the first TTI and the second TTI, a third control message that indicates a third scheduling offset for a third transmission, where the third scheduling offset is greater than or equal to the first scheduling offset threshold and indicates that the third transmission is scheduled in a fourth TTI that occurs after the first TTI in accordance with the third scheduling offset.

Additionally, or alternatively, the communications manager 820 may support wireless communications for a UE in accordance with examples as disclosed herein. The first communication configuration component 840 is capable of, configured to, or operable to support a means for receiving, during a first TTI and in accordance with a first communication configuration, a first control message indicating that a first transmission is scheduled in a second TTI that occurs after the first TTI. The second communication configuration component 845 is capable of, configured to, or operable to support a means for monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

In some examples, the third communication configuration component 865 is capable of, configured to, or operable to support a means for receiving, during a third TTI in accordance with a third communication configuration, a second control message indicating that a second transmission is scheduled in a fourth TTI that occurs after the third TTI based on a trigger event. In some examples, the trigger event includes a PDCCH skipping indication, an SSSG change indication, an end of burst indication, a BWP indication, or any combination thereof. In some examples, the trigger event includes an expiration of a timer. In some examples, a duration of the timer is reset based on receipt of each respective control message. In some examples, the third communication configuration is the same as to the first communication configuration.

In some examples, the first communication configuration component 840 is capable of, configured to, or operable to support a means for receiving, during a third TTI and in accordance with the first communication configuration, a second control message indicating that a second transmission is scheduled in a fourth TTI that occurs after the third TTI. In some examples, the communication configuration indication component 870 is capable of, configured to, or operable to support a means for transmitting an indication that the UE received the second control message in accordance with the first communication configuration based on the second transmission being associated with the second communication configuration. In some examples, to support transmitting the indication, the first communication configuration component 840 is capable of, configured to, or operable to support a means for transmitting a feedback message associated with the second control message, the feedback message including a NACK indication.

In some examples, the transmission monitoring component 830 is capable of, configured to, or operable to support a means for monitoring for, or transmitting, the second transmission in the fourth TTI and in accordance with the second communication configuration. In some examples, the second communication configuration component 845 is capable of, configured to, or operable to support a means for receiving, during a fifth TTI and in accordance with the second communication configuration, a third control message indicating a third transmission, where the first communication configuration is changed to the second communication configuration based on the second transmission being associated with the second communication configuration.

In some examples, the control signaling component 875 is capable of, configured to, or operable to support a means for receiving control signaling that enables or disables the UE to transmit the indication, change to the second communication configuration, or both, based on the second transmission being associated with the second communication configuration.

In some examples, the first communication configuration component 840 is capable of, configured to, or operable to support a means for receiving, during a third TTI and in accordance with the first communication configuration, a second control message indicating that a first uplink transmission is scheduled in a fourth TTI that occurs after the third TTI. In some examples, the communication configuration indication component 870 is capable of, configured to, or operable to support a means for transmitting an indication that the UE received the second control message in accordance with the first communication configuration based on the first uplink transmission being associated with the second communication configuration. In some examples, the communication configuration indication component 870 is capable of, configured to, or operable to support a means for transmitting uplink control information including the indication.

In some examples, the control signaling component 875 is capable of, configured to, or operable to support a means for receiving control signaling that enables or disables the UE to transmit the indication when the first uplink transmission is associated with the second communication configuration. In some examples, the first communication configuration is changed to the second communication configuration starting from the second TTI.

In some examples, the first communication configuration component 840 is capable of, configured to, or operable to support a means for receiving, between the first TTI and the second TTI, a second control message indicating that a second transmission is scheduled in a fourth TTI that occurs after the first TTI, where the second control message is received in accordance with the first communication configuration.

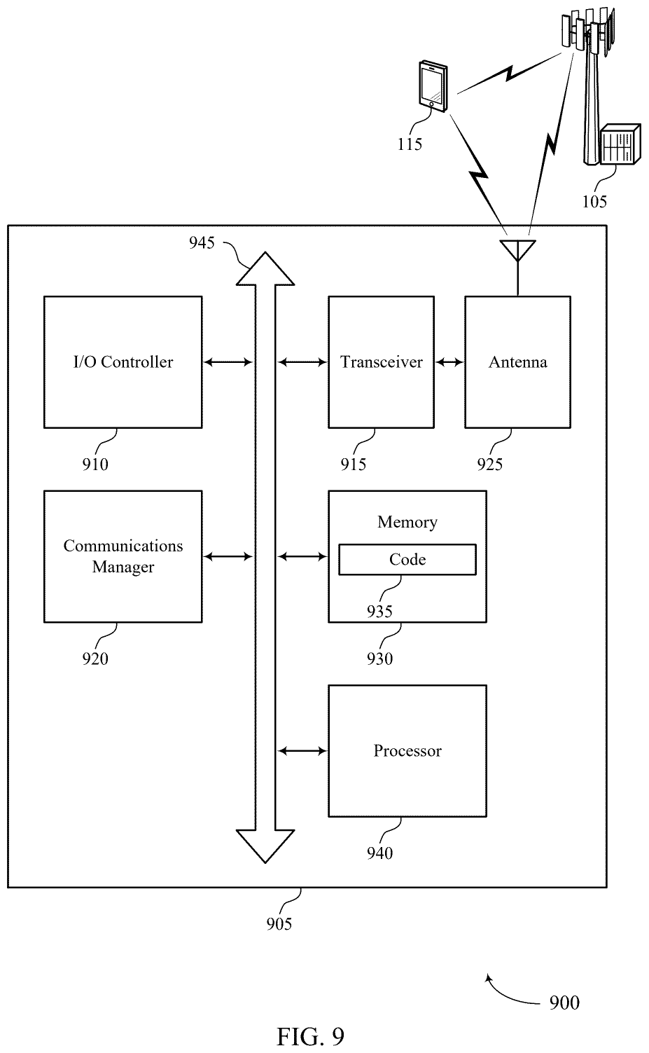

FIG. 9 shows a diagram of a system 900 including a device 905 that supports automatic scheduling offset threshold in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting automatic scheduling offset threshold). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications for a UE in accordance with examples as disclosed herein. For example, the communications manager 920 is capable of, configured to, or operable to support a means for receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset. The communications manager 920 is capable of, configured to, or operable to support a means for monitoring for, or transmitting, the first transmission during the second TTI. The communications manager 920 is capable of, configured to, or operable to support a means for receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message.

Additionally, or alternatively, the communications manager 920 may support wireless communications for a UE in accordance with examples as disclosed herein. For example, the communications manager 920 is capable of, configured to, or operable to support a means for receiving, during a first TTI and in accordance with a first communication configuration, a first control message indicating that a first transmission is scheduled in a second TTI that occurs after the first TTI. The communications manager 920 is capable of, configured to, or operable to support a means for monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message.

By including or configuring the communications manager 920 in accordance with examples as described herein, the device 905 may support techniques for improved communication reliability, reduced power consumption, more efficient utilization of communication resources, and longer battery life, among other advantages.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of automatic scheduling offset threshold as described herein, or the at least one processor 940 and the at least one memory 930 may be otherwise configured to, individually or collectively, perform or support such operations.

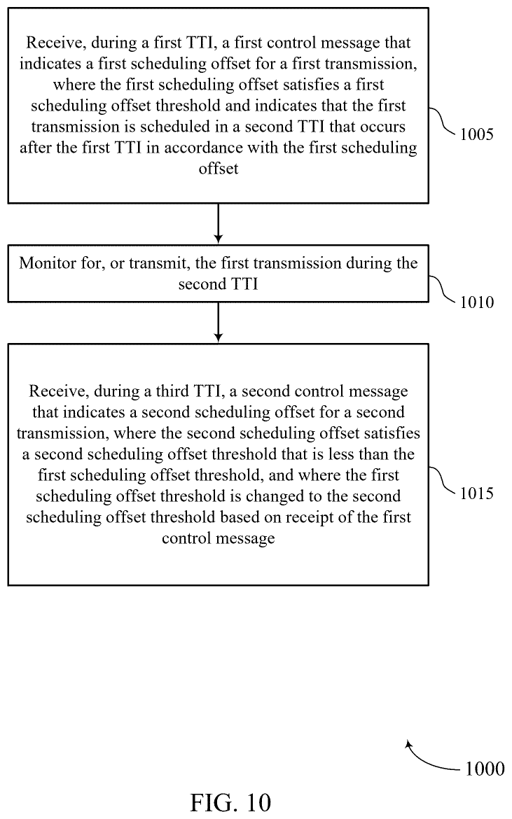

FIG. 10 shows a flowchart illustrating a method 1000 that supports automatic scheduling offset threshold in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving, during a first TTI, a first control message that indicates a first scheduling offset for a first transmission, where the first scheduling offset satisfies a first scheduling offset threshold and indicates that the first transmission is scheduled in a second TTI that occurs after the first TTI in accordance with the first scheduling offset. The operations of 1005 may be performed in accordance with examples as disclosed herein. In some examples, aspects of the operations of 1005 may be performed by a satisfied first scheduling offset threshold component 825 as described with reference to FIG. 8.

At 1010, the method may include monitoring for, or transmitting, the first transmission during the second TTI. The operations of 1010 may be performed in accordance with examples as disclosed herein. In some examples, aspects of the operations of 1010 may be performed by a transmission monitoring component 830 as described with reference to FIG. 8.

At 1015, the method may include receiving, during a third TTI, a second control message that indicates a second scheduling offset for a second transmission, where the second scheduling offset satisfies a second scheduling offset threshold that is less than the first scheduling offset threshold, and where the first scheduling offset threshold is changed to the second scheduling offset threshold based on receipt of the first control message. The operations of 1015 may be performed in accordance with examples as disclosed herein. In some examples, aspects of the operations of 1015 may be performed by a second scheduling offset threshold component 835 as described with reference to FIG. 8.

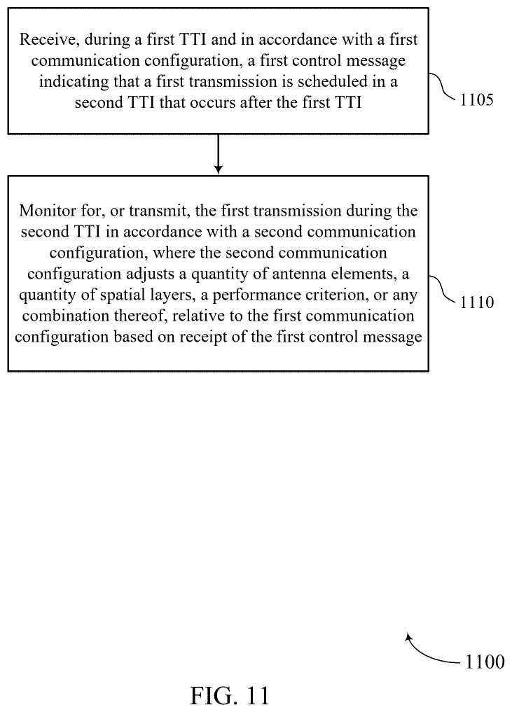

FIG. 11 shows a flowchart illustrating a method 1100 that supports automatic scheduling offset threshold in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving, during a first TTI and in accordance with a first communication configuration, a first control message indicating that a first transmission is scheduled in a second TTI that occurs after the first TTI. The operations of 1105 may be performed in accordance with examples as disclosed herein. In some examples, aspects of the operations of 1105 may be performed by a first communication configuration component 840 as described with reference to FIG. 8.

At 1110, the method may include monitoring for, or transmitting, the first transmission during the second TTI in accordance with a second communication configuration, where the second communication configuration adjusts a quantity of antenna elements, a quantity of spatial layers, a performance criterion, or any combination thereof, relative to the first communication configuration based on receipt of the first control message. The operations of 1110 may be performed in accordance with examples as disclosed herein. In some examples, aspects of the operations of 1110 may be performed by a second communication configuration component 845 as described with reference to FIG. 8.

The following provides an overview of aspects of the present disclosure:

Aspect 1: A method for wireless communications for a UE, comprising: receiving, during a first TTI, a first control message that indicates a first scheduling offset for a first transmission, wherein the first scheduling offset satisfies a first scheduling offset threshold and indicates that the first transmission is scheduled in a second TTI that occurs after the first TTI in accordance with the first scheduling offset; monitoring for, or transmitting, the first transmission during the second TTI; and receiving, during a third TTI, a second control message that indicates a second scheduling offset for a second transmission, wherein the second scheduling offset satisfies a second scheduling offset threshold that is less than the first scheduling offset threshold, and wherein the first scheduling offset threshold is changed to the second scheduling offset threshold based at least in part on receipt of the first control message.

Aspect 2: The method of aspect 1, further comprising: receiving, during a fourth TTI, a third control message that indicates a third scheduling offset for a third transmission, wherein the third scheduling offset satisfies a third scheduling offset threshold and indicates that the third transmission is scheduled in a fifth TTI that occurs after the fourth TTI in accordance with the third scheduling offset, and wherein the second scheduling offset threshold is changed to the third scheduling offset threshold based at least in part on a trigger event.

Aspect 3: The method of aspect 2, wherein the trigger event comprises a PDCCH skipping indication, an SSSG change indication, an end of burst indication, a BWP change indication, or any combination thereof.

Aspect 4: The method of aspect 2, wherein the trigger event comprises an expiration of a timer, and a duration of the timer is reset based at least in part on receipt of each respective control message.

Aspect 5: The method of any of aspects 2 through 4, wherein the third scheduling offset threshold is equal to the first scheduling offset threshold.

Aspect 6: The method of any of aspects 1 through 5, further comprising: receiving, during a fourth TTI, a third control message that indicates a third scheduling offset for a third transmission, wherein the third scheduling offset does not satisfy the first scheduling offset threshold; and transmitting an indication that the third scheduling offset does not satisfy the first scheduling offset threshold.

Aspect 7: The method of aspect 6, wherein transmitting the indication comprises: transmitting a feedback message associated with the third control message, the feedback message comprising a NACK indication.

Aspect 8: The method of any of aspects 6 through 7, further comprising: monitoring for, or transmitting, the third transmission during a fifth TTI; and receiving, during a sixth TTI, a fourth control message that indicates a fourth scheduling offset for a fourth transmission, wherein the fourth scheduling offset satisfies the second scheduling offset threshold, and wherein the first scheduling offset threshold is changed to the second scheduling offset threshold based at least in part on the third scheduling offset not satisfying the first scheduling offset threshold.

Aspect 9: The method of aspect 8, further comprising: receiving control signaling that enables or disables the UE to transmit the indication, change to the second scheduling offset threshold, or both, based at least in part on the third scheduling offset not satisfying the first scheduling offset threshold.

Aspect 10: The method of any of aspects 1 through 9, further comprising: receiving, during a fourth TTI, a third control message that indicates a third scheduling offset for a first uplink transmission, wherein the third scheduling offset does not satisfy the first scheduling offset threshold; and transmitting an indication that the third scheduling offset does not satisfy the first scheduling offset threshold.

Aspect 11: The method of aspect 10, wherein transmitting the indication comprises: transmitting UCI comprising the indication.

Aspect 12: The method of any of aspects 10 through 11, further comprising: receiving control signaling that enables or disables the UE to transmit the indication when the third scheduling offset does not satisfy the first scheduling offset threshold.

Aspect 13: The method of any of aspects 1 through 12, wherein the first scheduling offset threshold is changed to the second scheduling offset threshold starting from the second TTI.

Aspect 14: The method of any of aspects 1 through 13, further comprising: receiving, between the first TTI and the second TTI, a third control message that indicates a third scheduling offset for a third transmission, wherein the third scheduling offset is greater than or equal to the first scheduling offset threshold and indicates that the third transmission is scheduled in a fourth TTI that occurs after the first TTI in accordance with the third scheduling offset.

Aspect 15: A method for wireless communications for a UE, comprising: receiving, during a first TTI and in accordance with a first communication configuration, a first control message indicating that a first transmission is scheduled in a second TTI that occurs after the first TTI; and monitoring for, or transmitting, the first transmission during the second TTI in accordance with a second communication configuration, wherein the second communication configuration adjusts a quantity of antenna elements, a quantity of spatial layers, a performance criterion, or any combination thereof, relative to the first communication configuration based at least in part on receipt of the first control message.

Aspect 16: The method of aspect 15, further comprising: receiving, during a third TTI in accordance with a third communication configuration, a second control message indicating that a second transmission is scheduled in a fourth TTI that occurs after the third TTI based at least in part on a trigger event.

Aspect 17: The method of aspect 16, wherein the trigger event comprises a PDCCH skipping indication, an SSSG change indication, an end of burst indication, a BWP change indication, or any combination thereof.

Aspect 18: The method of aspect 16, wherein the trigger event comprises an expiration of a timer, and a duration of the timer is reset based at least in part on receipt of each respective control message.

Aspect 19: The method of any of aspects 16 through 18, wherein the third communication configuration is the same as to the first communication configuration.

Aspect 20: The method of any of aspects 15 through 19, further comprising: receiving, during a third TTI and in accordance with the first communication configuration, a second control message indicating that a second transmission is scheduled in a fourth TTI that occurs after the third TTI; and transmitting an indication that the UE received the second control message in accordance with the first communication configuration based at least in part on the second transmission being associated with the second communication configuration.

Aspect 21: The method of aspect 20, wherein transmitting the indication comprises: transmitting a feedback message associated with the second control message, the feedback message comprising a NACK indication.

Aspect 22: The method of any of aspects 20 through 21, further comprising: monitoring for, or transmitting, the second transmission in the fourth TTI and in accordance with the second communication configuration; and receiving, during a fifth TTI and in accordance with the second communication configuration, a third control message indicating a third transmission, wherein the first communication configuration is changed to the second communication configuration based at least in part on the second transmission being associated with the second communication configuration.

Aspect 23: The method of aspect 22, further comprising: receiving control signaling that enables or disables the UE to transmit the indication, change to the second communication configuration, or both, based at least in part on the second transmission being associated with the second communication configuration.

Aspect 24: The method of any of aspects 15 through 23, further comprising: receiving, during a third TTI and in accordance with the first communication configuration, a second control message indicating that a first uplink transmission is scheduled in a fourth TTI that occurs after the third TTI; and transmitting an indication that the UE received the second control message in accordance with the first communication configuration based at least in part on the first uplink transmission being associated with the second communication configuration.

Aspect 25: The method of aspect 24, transmitting the indication comprises: transmitting uplink control information comprising the indication.

Aspect 26: The method of any of aspects 24 through 25, further comprising: receiving control signaling that enables or disables the UE to transmit the indication when the first uplink transmission is associated with the second communication configuration.

Aspect 27: The method of any of aspects 15 through 26, wherein the first communication configuration is changed to the second communication configuration starting from the second TTI.

Aspect 28: The method of any of aspects 15 through 27, further comprising: receiving, between the first TTI and the second TTI, a second control message indicating that a second transmission is scheduled in a fourth TTI that occurs after the first TTI, wherein the second control message is received in accordance with the first communication configuration.

Aspect 29: An apparatus for wireless communications for a UE, comprising one or more memories storing processor-executable code, and one or more processors coupled with the one or more memories and individually or collectively operable to execute the code to cause the apparatus to perform a method of any of aspects 1 through 14.

Aspect 30: An apparatus for wireless communications for a UE, comprising at least one means for performing a method of any of aspects 1 through 14.

Aspect 31: A non-transitory computer-readable medium storing code for wireless communications for a UE, the code comprising instructions executable by one or more processors to perform a method of any of aspects 1 through 14.

Aspect 32: An apparatus for wireless communications for a UE, comprising one or more memories storing processor-executable code, and one or more processors coupled with the one or more memories and individually or collectively operable to execute the code to cause the apparatus to perform a method of any of aspects 15 through 28.

Aspect 33: An apparatus for wireless communications for a UE, comprising at least one means for performing a method of any of aspects 15 through 28.

Aspect 34: A non-transitory computer-readable medium storing code for wireless communications for a UE, the code comprising instructions executable by one or more processors to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more memories storing processor-executable code; and
one or more processors coupled with the one or more memories and individually or collectively operable to execute the code to cause the apparatus to:
receive, during a first transmission time interval, a first control message that indicates a first scheduling offset for a first transmission, wherein the first scheduling offset satisfies a first scheduling offset threshold and indicates that the first transmission is scheduled in a second transmission time interval that occurs after the first transmission time interval in accordance with the first scheduling offset;
monitor for, or transmit, the first transmission during the second transmission time interval; and
receive, during a third transmission time interval, a second control message that indicates a second scheduling offset for a second transmission, wherein the second scheduling offset satisfies a second scheduling offset threshold that is less than the first scheduling offset threshold, and wherein the first scheduling offset threshold is changed to the second scheduling offset threshold based at least in part on receipt of the first control message.

2. The apparatus of claim 1, wherein the one or more processors are individually or collectively further operable to execute the code to cause the apparatus to:
receive, during a fourth transmission time interval, a third control message that indicates a third scheduling offset for a third transmission, wherein the third scheduling offset satisfies a third scheduling offset threshold and indicates that the third transmission is scheduled in a fifth transmission time interval that occurs after the fourth transmission time interval in accordance with the third scheduling offset, and wherein the second scheduling offset threshold is changed to the third scheduling offset threshold based at least in part on a trigger event.

3. The apparatus of claim 2, wherein the trigger event comprises a physical downlink control channel skipping indication, a search space set group change indication, an end of burst indication, a bandwidth part change indication, or any combination thereof.

4. The apparatus of claim 2, wherein:
the trigger event comprises an expiration of a timer, and
a duration of the timer is reset based at least in part on receipt of each respective control message.

5. The apparatus of claim 2, wherein the third scheduling offset threshold is equal to the first scheduling offset threshold.

6. The apparatus of claim 1, wherein the one or more processors are individually or collectively further operable to execute the code to cause the apparatus to:
receive, during a fourth transmission time interval, a third control message that indicates a third scheduling offset for a third transmission, wherein the third scheduling offset does not satisfy the first scheduling offset threshold; and
transmit an indication that the third scheduling offset does not satisfy the first scheduling offset threshold.

7. The apparatus of claim 6, wherein, to transmit the indication, the one or more processors are individually or collectively operable to execute the code to cause the apparatus to:
transmit a feedback message associated with the third control message, the feedback message comprising a negative acknowledgment indication.

8. The apparatus of claim 6, wherein the one or more processors are individually or collectively further operable to execute the code to cause the apparatus to:
monitor for, or transmit, the third transmission during a fifth transmission time interval; and
receive, during a sixth transmission time interval, a fourth control message that indicates a fourth scheduling offset for a fourth transmission, wherein the fourth scheduling offset satisfies the second scheduling offset threshold, and wherein the first scheduling offset threshold is changed to the second scheduling offset threshold based at least in part on the third scheduling offset not satisfying the first scheduling offset threshold.

9. The apparatus of claim 8, wherein the one or more processors are individually or collectively further operable to execute the code to cause the apparatus to:
receive control signaling that enables or disables the UE to transmit the indication, change to the second scheduling offset threshold, or both, based at least in part on the third scheduling offset not satisfying the first scheduling offset threshold.

10. The apparatus of claim 1, wherein the one or more processors are individually or collectively further operable to execute the code to cause the apparatus to:
receive, during a fourth transmission time interval, a third control message that indicates a third scheduling offset for a first uplink transmission, wherein the third scheduling offset does not satisfy the first scheduling offset threshold; and
transmit an indication that the third scheduling offset does not satisfy the first scheduling offset threshold.

11. The apparatus of claim 10, wherein, to transmit the indication, the one or more processors are individually or collectively operable to execute the code to cause the apparatus to:
transmit uplink control information comprising the indication.

12. The apparatus of claim 10, wherein the one or more processors are individually or collectively further operable to execute the code to cause the apparatus to:
receive control signaling that enables or disables the UE to transmit the indication when the third scheduling offset does not satisfy the first scheduling offset threshold.

13. The apparatus of claim 1, wherein the first scheduling offset threshold is changed to the second scheduling offset threshold starting from the second transmission time interval.

14. The apparatus of claim 1, wherein the one or more processors are individually or collectively further operable to execute the code to cause the apparatus to:
receive, between the first transmission time interval and the second transmission time interval, a third control message that indicates a third scheduling offset for a third transmission, wherein the third scheduling offset is greater than or equal to the first scheduling offset threshold and indicates that the third transmission is scheduled in a fourth transmission time interval that occurs after the first transmission time interval in accordance with the third scheduling offset.

15. An apparatus for wireless communications at a user equipment (UE), comprising:
one or more memories storing processor-executable code; and
one or more processors coupled with the one or more memories and individually or collectively operable to execute the code to cause the apparatus to:
receive, during a first transmission time interval and in accordance with a first communication configuration, a first control message indicating that a first transmission is scheduled in a second transmission time interval that occurs after the first transmission time interval; and
monitor for, or transmit, the first transmission during the second transmission time interval in accordance with a second communication configuration, wherein the second communication configuration adjusts a quantity of antenna elements, a quantity of spatial layers, a performance criterion, or any combination thereof, relative to the first communication configuration based at least in part on receipt of the first control message.

16. The apparatus of claim 15, wherein the one or more processors are individually or collectively further operable to execute the code to cause the apparatus to:
receive, during a third transmission time interval in accordance with a third communication configuration, a second control message indicating that a second transmission is scheduled in a fourth transmission time interval that occurs after the third transmission time interval based at least in part on a trigger event.

17. The apparatus of claim 16, wherein the trigger event comprises a physical downlink control channel skipping indication, a search space set group change indication, an end of burst indication, a bandwidth part change indication, or any combination thereof.

18. The apparatus of claim 16, wherein:
the trigger event comprises an expiration of a timer, and
a duration of the timer is reset based at least in part on receipt of each respective control message.

19. The apparatus of claim 16, wherein the third communication configuration is the same as to the first communication configuration.

20. The apparatus of claim 15, wherein the one or more processors are individually or collectively further operable to execute the code to cause the apparatus to:
receive, during a third transmission time interval and in accordance with the first communication configuration, a second control message indicating that a second transmission is scheduled in a fourth transmission time interval that occurs after the third transmission time interval; and
transmit an indication that the UE received the second control message in accordance with the first communication configuration based at least in part on the second transmission being associated with the second communication configuration.

21. The apparatus of claim 20, wherein, to transmit the indication, the one or more processors are individually or collectively operable to execute the code to cause the apparatus to:
transmit a feedback message associated with the second control message, the feedback message comprising a negative acknowledgment indication.

22. The apparatus of claim 20, wherein the one or more processors are individually or collectively further operable to execute the code to cause the apparatus to:
monitor for, or transmit, the second transmission in the fourth transmission time interval and in accordance with the second communication configuration; and
receive, during a fifth transmission time interval and in accordance with the second communication configuration, a third control message indicating a third transmission, wherein the first communication configuration is changed to the second communication configuration based at least in part on the second transmission being associated with the second communication configuration.

23. The apparatus of claim 22, wherein the one or more processors are individually or collectively further operable to execute the code to cause the apparatus to:
receive control signaling that enables or disables the UE to transmit the indication, change to the second communication configuration, or both, based at least in part on the second transmission being associated with the second communication configuration.

24. The apparatus of claim 15, wherein the one or more processors are individually or collectively further operable to execute the code to cause the apparatus to:
receive, during a third transmission time interval and in accordance with the first communication configuration, a second control message indicating that a first uplink transmission is scheduled in a fourth transmission time interval that occurs after the third transmission time interval; and
transmit an indication that the UE received the second control message in accordance with the first communication configuration based at least in part on the first uplink transmission being associated with the second communication configuration.

25. The apparatus of claim 24, wherein, to transmit the indication, the one or more processors are individually or collectively operable to execute the code to cause the apparatus to:
transmit uplink control information comprising the indication.

26. The apparatus of claim 24, wherein the one or more processors are individually or collectively further operable to execute the code to cause the apparatus to:
receive control signaling that enables or disables the UE to transmit the indication when the first uplink transmission is associated with the second communication configuration.

27. The apparatus of claim 15, wherein the first communication configuration is changed to the second communication configuration starting from the second transmission time interval.

28. The apparatus of claim 15, wherein the one or more processors are individually or collectively further operable to execute the code to cause the apparatus to:
receive, between the first transmission time interval and the second transmission time interval, a second control message indicating that a second transmission is scheduled in a fourth transmission time interval that occurs after the first transmission time interval, wherein the second control message is received in accordance with the first communication configuration.

29. A method for wireless communications for a user equipment (UE), comprising:
receiving, during a first transmission time interval, a first control message that indicates a first scheduling offset for a first transmission, wherein the first scheduling offset satisfies a first scheduling offset threshold and indicates that the first transmission is scheduled in a second transmission time interval that occurs after the first transmission time interval in accordance with the first scheduling offset;
monitoring for, or transmitting, the first transmission during the second transmission time interval; and
receiving, during a third transmission time interval, a second control message that indicates a second scheduling offset for a second transmission, wherein the second scheduling offset satisfies a second scheduling offset threshold that is less than the first scheduling offset threshold, and wherein the first scheduling offset threshold is changed to the second scheduling offset threshold based at least in part on receipt of the first control message.

30. A method for wireless communications for a user equipment (UE), comprising:
receiving, during a first transmission time interval and in accordance with a first communication configuration, a first control message indicating that a first transmission is scheduled in a second transmission time interval that occurs after the first transmission time interval; and
monitoring for, or transmitting, the first transmission during the second transmission time interval in accordance with a second communication configuration, wherein the second communication configuration adjusts a quantity of antenna elements, a quantity of spatial layers, a performance criterion, or any combination thereof, relative to the first communication configuration based at least in part on receipt of the first control message.
